(19) United States
(12) Patent Application Publication
(10) Pub. No.: US 2020/0213147 A1
(43) Pub. Date: Jul. 2, 2020

(54) ON-VEHICLE ETHERNET CONNECTOR

(71) Applicant: AMPHENOL EAST ASIA ELECTRONIC TECHNOLOGY (SHEN ZHEN) CO., LTD., Shen Zhen (CN)

(72) Inventors: DAN-REN HE, SHEN ZHEN (CN); ZUXIN LI, SHEN ZHEN (CN)

(21) Appl. No.: 16/232,702

(22) Filed: Dec. 26, 2018

(51) Int. Cl. H04L 12/40; H04L 12/02; H01R 13/64; H01R 13/6597; H01R 24/64

(52) U.S. Cl. CPC H04L 12/40; H04L 12/02; H04L 2012/40273; H01R 13/6597; H01R 24/64; H01R 13/64

(57) ABSTRACT

An on-vehicle Ethernet connector includes a housing, a terminal, a shield member, and an ESD casing; the housing formed in a barrel shape and having a U-shaped protection structure; the terminal inserted on a bottom of the housing; the shield member inserted in the pillar bodies; the ESD casing mounted around the housing; the U-shaped protection member disposed in the housing and having a plurality of pillar bodies connected and arranged around the terminal; and a sectional view of the plurality of pillar bodies around the terminal being formed in a U shape. The U-shaped protection structure surrounding the terminal prevents the terminal from being accidentally touched, thus increasing the stability and security of the connector. The shield member shields around the terminal. The U-shaped protection structure formed of plastic material provides dust-proof, water-proof, insulation, and accidental contact prevention.

### BACKGROUND OF THE INVENTION

### 1. Field of the Invention

The present invention relates to connectors, and more particularly, to an on-vehicle Ethernet connector.

### 2. Description of the Related Art

Ethernet is the most common communication protocol standard which has a wide range of application, with advantages of being technically mature, highly standardized, having high bandwidth, and lower cost. As on-vehicle electronic systems gradually becoming much more precise and delicate, vehicles are now provided with functions such as auto-driving, camera, and information entertainments. Therefore, on-vehicle Ethernet is the best choice for integrating such various functions.

With the need of communication between different calculation units and domains of on-vehicle Ethernet continuously growing, on-vehicle electronics become more complicated. Therefore, the demand upon security, stability, and transmission rate of the on-vehicle Ethernet connector increase as well.

### SUMMARY OF THE INVENTION

For improving the issues above, an on-vehicle Ethernet connector in accordance with the present invention is disclosed, comprising a housing, a terminal, a shield member, and an ESD casing; the housing formed in a barrel shape; the terminal inserted on a bottom portion of the housing; the shield member is inserted on an inner wall of the housing; the ESD casing mounted around an outer wall of the housing; the housing having a U-shaped protection structure; the U-shaped protection member disposed in the housing and comprising a plurality of pillar bodies; the pillar bodies being connected and arranged around the terminal; and a sectional view of the plurality of pillar bodies around the terminal being formed in a U shape.

Preferably, the shield member is inserted in the pillar bodies.

Preferably, the pillar bodies of the U-shaped protection structure are formed of a plastic material.

With such configuration, the present invention provides several beneficial functions.

Compared to known technical solutions, the present invention applies the U-shaped protection structure formed of a plurality of pillar bodies, which surrounds the terminal for fully preventing the terminal from being accidentally touched, thus increasing the stability and security of the connector.

In addition, the shield member is inserted in the pillar bodies for shielding around the terminal, thus providing a further shielding function.

In addition, the U-shaped protection structure formed of plastic material provides better dust-proof, water-proof, insulation, and accidental contact prevention functions.

### BRIEF DESCRIPTION OF THE DRAWINGS

FIG. 1 is an exploded view of the on-vehicle Ethernet connector in accordance with an embodiment of the present invention.

FIG. 2 is a schematic view illustrating the U-shaped protection structure in accordance with an embodiment of the present invention.

### DETAILED DESCRIPTION OF THE INVENTION

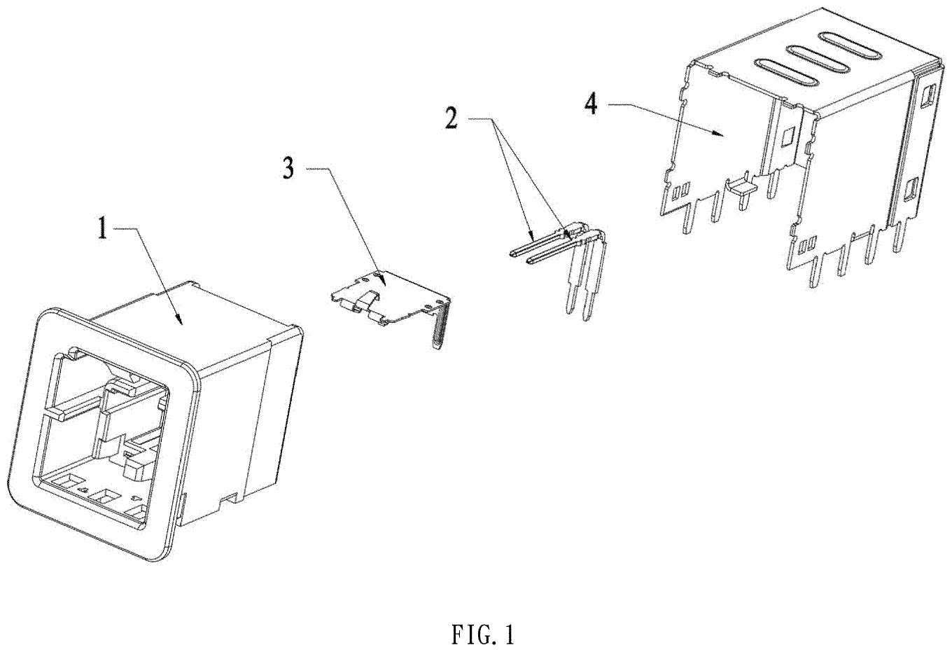

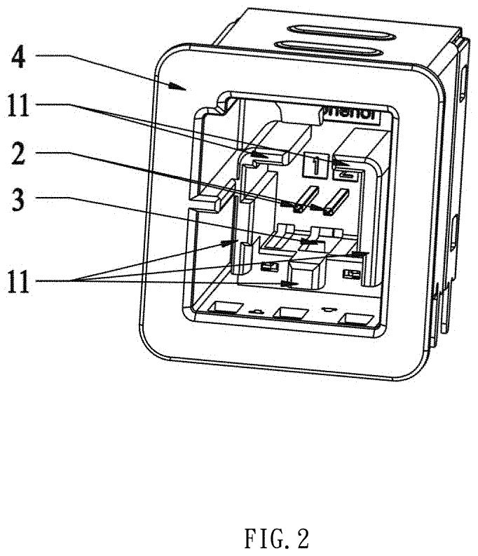

The embodiment of the present invention is illustrated by reference of but not limited to FIG. 1 and FIG. 2.

### Embodiment 1

An on-vehicle Ethernet connector, as shown by FIG. 1, comprises a housing 1, a terminal 2, a shield member 3, and an ESD casing 4. The housing 1 is formed in a barrel shape. The terminal 2 inserted on a bottom portion of the housing 1. The shield member 3 is inserted on an inner wall of the housing 1. The ESD casing 4 is mounted around an outer wall of the housing 1. As shown by FIG. 2, the housing 1 has a U-shaped protection structure 11. The U-shaped protection member 11 is disposed in the housing 1 and comprising a plurality of pillar bodies. The pillar bodies are connected and arranged around the terminal 2. The sectional view of the plurality of pillar bodies around the terminal 2 is formed in a U shape. The shield member 3 is inserted in the pillar bodies.

The pillar bodies of the U-shaped protection structure 11 are formed of a plastic material.

Based on common technical knowledge, the present invention is allowed to be realized by solutions not departing from the spirit and scope of the invention. Therefore, although particular embodiments of the invention have been described in detail for purposes of illustration, various modifications and enhancements may be made. Therefore, the invention is not to be limited except as by the appended claims. All modifications and enhancements within the scope of the present invention achieving equivalent effects and functions of claims are included by the present invention.

What is claimed is:

1. An on-vehicle Ethernet connector, comprising:
a housing, a terminal, a shield member, and an ESD casing;
the housing formed in a barrel shape;
the terminal inserted on a bottom portion of the housing;
the shield member is inserted on an inner wall of the housing;
the ESD casing mounted around an outer wall of the housing;
the housing having a U-shaped protection structure;
the U-shaped protection member disposed in the housing and comprising a plurality of pillar bodies;
the pillar bodies being connected and arranged around the terminal; and
a sectional view of the plurality of pillar bodies around the terminal being formed in a U shape.

2. The connector of claim 1, wherein the shield member is inserted in the pillar bodies.

3. The connector of claim 1, wherein the pillar bodies of the U-shaped protection structure are formed of a plastic material.
